(19) United States
(12) Patent Application Publication
(10) Pub. No.: US 2006/0104082 A1
(43) Pub. Date: May 18, 2006

(54) Light collector

(76) Inventors: James Bruce Franklin, Camperdown (AU); Geoffrey Burton Smith, Epping (AU)

Correspondence Address: LADAS & PARRY LLP, 224 SOUTH MICHIGAN AVENUE, SUITE 1600, CHICAGO, IL, 60604, US

(21) Appl. No.: 10/533,704

(22) PCT Filed: Nov. 5, 2003
(86) PCT No.: PCT/AU03/01457

§ 371 Date: Sep. 9, 2005

(30) Foreign Application Priority Data
Nov. 5, 2002 (AU) 2002952481

(51) Int. Cl. F21V 7/04; G02B 17/00; G02B 21/00

(52) U.S. Cl. 362/557

(57) ABSTRACT

The present invention provides a light collector. The light collector has a concentration C of dye molecules which absorb and emit light. The dye molecules are dispersed in a light transmissive medium and the concentration C is selected to reduce attenuation that light will suffer due to re-absorption or scattering in the main emission wavelength range of the dye molecules so that the combined emission and absorption efficiency of the light collector is increased.

### FIELD OF THE INVENTION

The present invention broadly relates to a light collector for use in a light collection and light transport system.

### BACKGROUND OF THE INVENTION

Electrical lighting systems are often very inefficient; usually more than 90% of the electrical energy is not converted into useful light. Sunlight, however, is freely available and attempts have been made to collect sunlight for illumination purposes.

U.S. Pat. No. 6,059,438 discloses a sunlight collecting and transmitting system. The disclosed system comprises three collector sheets. The three sheets are stacked on top of each other and are composed of a polymeric material that is doped with fluorescent dye molecules. The dye molecules absorb sunlight of a particular wavelength and subsequently emit fluorescent light having a slightly longer wavelength. A first sheet is doped with blue dye molecules, a second sheet is doped with green dye molecules and a third sheet is doped with red dye molecules. The generated fluorescent light is guided by internal reflection within the collector sheets and white light is generated by combining the blue, green and red fluorescent light. One of the advantages of this sunlight collecting and transmitting system is that the emission of the fluorescent light does not occur in any preferred directions while the absorption is only weakly sensitive to the distribution of incident rays at any one time. That is, the collector responds well to both diffuse and beam or specular solar radiation. Focussing concentrators in contrast give almost no useful output under diffuse partially cloudy skies. The efficiency of this system depends largely on the total solar flux falling on the collector modified only slightly according to the average incident direction of the incoming sunlight.

However, the intensity of the generated fluorescent light that is emitted at any edge does not increase in direct proportion to the increase in solar energy incident on the light collector as a result of increase in its area since a larger collector requires more fluorescently emitted light to travel further before exit from the collector and so there is a greater chance it will be lost, due to various loss processes that occur in practice. The dye molecules may introduce defects in the matrix of the material that forms the light collector. These defects result in optical scattering of light and the resultant intensity losses increases with the distance light travels. Further, losses occur due to re-absorption of emitted light.

In general, loss mechanism in the light collector sheet may be divided into two components: loss mechanism “m” relates to losses that guided light will suffer due to attenuation owing to scattering at structural defects of the matrix material in which the dye molecules are dispersed and loss mechanism “d” involves scattering and re-absorption at the dispersed dye-molecules themselves. Losses that guided light will suffer may be quantified by the attenuation half lengths hₘ and h_{d} which are the distances at which the intensity of fluorescent light emitted at a first position is reduced by 50% owing to the respective losses. A third attenuation half length h_{m+d} is defined as the distance at which the intensity of fluorescent light emitted at a first position is reduced by 50% owing to both losses mechanisms.

### SUMMARY OF THE INVENTION

The present invention provides in a first aspect a light collector having a dye molecule concentration C, the dye molecules being dispersed in a light transmissive medium, the concentration C being selected to reduce attenuation that light will suffer due to re-absorption or scattering in the main emission wavelength range of the dye molecules so that the combined emission and absorption efficiency of the light collector is increased.

The present invention provides in a second aspect a light collector having a dye molecule concentration C and a corresponding output of fluorescence light Lₒᵤₜ, the dye molecules being dispersed in a light transmissive medium and the concentration C being lower than 500 ppm, the concentration C being smaller than a concentration C′ and the output of fluorescence light Lₒᵤₜ being larger than the output the light collector would have if the concentration is C′.

Using high quality light collectors having a very low density of defects, the inventors made the surprising discovery that the spectral range in which dye concentration linked loss occurs extends well into the main emission band. The inventors have also discovered that, if this extended loss tail which is linked to the presence of dye is taken into account, the dye concentration can be optimised and the increase in efficiency is significant in systems of useful dimensions. The optimum dye concentration is lower than previously predicted and the efficiency of light collectors having such dye concentration is significantly improved compared with light collectors that were designed using a method that does not take into account the extension of the weak loss tail into the main emission range.

In both aspects of the invention the light collector may have a thickness t and the concentration C may be selected so that the product of C and t is between 240 and 200 ppm*mm, between 200 and 160 ppm*mm, between 160 and 120 ppm*mm, between 120 and 80 ppm*mm, between 80 and 40 ppm*mm, between 40 and 20 ppm*mm or less than 20 ppm*mm.

In a specific embodiment, the dye concentration is selected such that attenuation that light will suffer due to re-absorption or scattering in the main emission wavelength range is reduced and the combined emission and absorption efficiency of the light collector is optimised.

The dye molecules typically are distributed such that at least a majority of the dye molecules are not directly bonded to one another. The dye molecules typically are substantially uniformly distributed throughout the light collector.

The present invention provides in a third aspect a method of fabricating a light collector being doped with dye molecules that, in use, absorb light having a wavelength within an absorption wavelength range and emit light having a wavelength within an emission wavelength range, the method comprising the step of calculating a concentration of the dye molecules taking into account the attenuation that emitted light will suffer owing to re-absorption or scattering in the main emission wavelength range and thereby taking into account that the fluorescence light output Lₒᵤₜ is reduced for dye concentrations above an optimum value.

The above-defined method may comprise the step of selecting the dimensions of the light collector and calculating the dye concentration for the selected dimensions. The step of calculating the dye concentration may also take into account reflection properties of a medium that will be positioned adjacent the light collector.

The wavelength range in which attenuation owing to re-absorption or dye related scattering is taken into account typically extends beyond a wavelength that corresponds to maximum emission intensity. For example, the wavelength range for which attenuation is taken into account may extend to a wavelength of at least 50 nm longer than the wavelength that corresponds to maximum emission intensity. For this calculation, attenuation over the thickness of the sheet is typically considered and measured with an accuracy of at least 1 part in 10³, typically at least 1 part in 10⁴.

The wavelength range in which attenuation owing to re-absorption or weak scattering is taken into account may be from 380 nm to 480 nm for light collector doped with dye molecules that, in use, emit violet fluorescent light. For a light collector that is doped with dye molecules that, in use, emit blue fluorescence radiation the wavelength range in which attenuation owing to re-absorption or weak scattering is taken into account may be from 400 to 580 nm. For a light collector that is doped with dye molecules that, in use, emit green fluorescence radiation the wavelength range in which attenuation owing to re-absorption or weak scattering is taken into account may be from 460 to 700 nm. For a light collector that is doped with dye molecules that, in use, emit red fluorescence radiation the wavelength range in which attenuation owing to re-absorption is taken into account may be from 530 nm to 700 nm.

In a specific embodiment the step of calculating the dye concentration is conducted such that a dye concentration for optimum combined absorption and emission efficiency is obtained.

The present invention provides in a fourth aspect a light collector fabricated by the above-defined method.

The invention will be more fully understood from the following description of specific embodiments. The description is provided with reference to the accompanying drawings.

### BRIEF DESCRIPTION OF THE DRAWINGS

FIG. 1 shows a light collector according to a specific embodiment,

FIG. 2 shows a co-ordinate system used for the calculations of a dye molecule concentration of a light collector shown in FIG. 1,

FIG. 3 shows a transmission versus wavelength plot for a the light collector shown in FIG. 1 and

FIG. 4 shows a light output versus dye concentration plot for calculated according to a specific embodiment.

### DETAILED DESCRIPTION OF SPECIFIC EMBODIMENTS

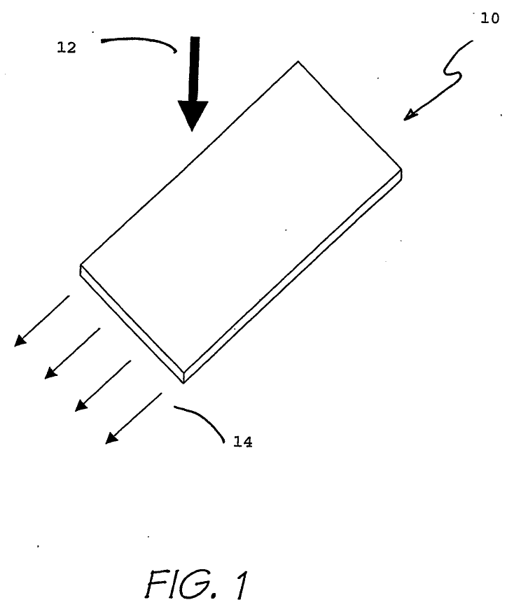

A light collector and a method of fabricating the light collector according to specific embodiments is now described. In general, the method concerns the fabrication of a light collector of the type shown in FIG. 1. The light collector 10 is doped with dye molecules that, in use, absorb light 12 having a wavelength within an absorption wavelength range and emit light 14 having a wavelength within an emission wavelength range. The method of fabricating the light collector 10 comprises the step of calculating an optimum concentration of the dye molecules taking into account the attenuation that emitted light will suffer (for example owing to re-absorption or scattering) in a wavelength range that extends across much or all of the emission wavelength range.

Initially the absorption or extinction coefficient A(λ) directly attributable to dye molecules at a known concentration x (x is in units of either wt % or dye molecules per unit volume) is measured from optical specular transmittance measurements at known thickness and concentration x in the host material which is known to have negligible scattering at the thicknesses used. For any concentration x_{c}, a coefficient α(λ) can be estimated from α(λ)=A(λ)(x_{c}/x). It is the dye concentration x_{c} which is optimised. The coefficient α(λ) is almost exclusively dependent on the dye absorption process which leads to fluorescence, but at long wavelengths λ, where it is relatively very weak and hence difficult to measure accurately in standard set ups, other dye induced loss processes may occur and make up a significant component of α(λ), if it is non zero at these wavelengths. [Though weak, these long wavelength losses linked to dye concentration can have a very significant impact on output in these systems. Data on complete systems indicates their importance.]

For these measurements the dye molecules should be dispersed fully, that is at a monomolecular level. Relatively high accuracy in transmittance data is required in the region where the absorption spectrum overlaps the fluorescence emission spectrum, especially where loss is small and relatively negligible in thin samples. Measurements through thicker samples or even along the length inside a long sheet are ideal, but need special instrumentation and light sources.

The ideal dye concentration will depend on collector length L and to some extent on width w and thickness t. Thus these design parameters have first to be established.

The output power spectrum at the collection edge of interest, ε(λ,L), is calculated from equation (1) at each dye concentration with α(λ) linear in concentration

$$ɛ ( λ , L ) = \frac{{ɛ}_{o} ( λ )}{\int {ɛ}_{o} ( {λ}^{′} ) ⅆ {λ}^{′}} \frac{{E}_{A}}{t ( \frac{π}{2} )} {\int }_{0}^{L} ⅆ l {\int }_{χ}^{π / 2} sin θ ⅆ θ {\int }_{0}^{arcsin ( \frac{cos χ}{sin θ} )} {ⅇ}^{\frac{- ( α ( λ ) + {α}_{m} ) l}{( sin θcos ϕ )}} ⅆ ϕ \qquad ( 1 )$$

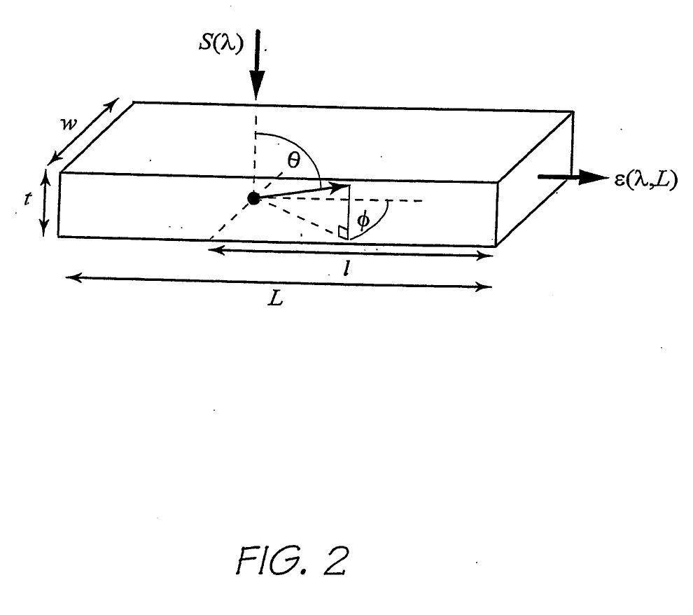

The fluorescent dye has a power spectrum εₒ(λ) (with SI units W·m⁻²·nm⁻ where the subscript “o” denotes the spectrum of emitted radiation prior to encountering other dye molecules). The absorbed energy per unit area is EA. FIG. 2 shows a coordinate system that illustrates the quantities used in the above equation. Angles φ and θ are standard spherical co-ordinates. χ is the critical angle of the matrix material for total internal reflection and αₘ represents any matrix or surface losses which are independent of dye molecules and hence not correlated to dye concentration. It is assumed here to be independent of wavelength. A detailed schematic of this geometry is given in [Swift P. D., Smith G. B. and Franklin J. (1999) “Light to light efficiencies in Luminescent Solar Concentrators”, SPIE Conference on Solar Optical Materials, pp. 21-28, Denver, Colo.]. The distance travelled by a particular ray emitted from the dye molecule before it reaches the output edge is l/sinθcosφ where l is the axial distance from the dye molecule to the output edge.

For the case in which sunlight is distributed uniformly over the top surface of the LSC (with area wL) at normal incidence, the absorbed energy per unit area, E_{A}, is

$${E}_{A} = \frac{( 1 - {R}_{c} ) \int ( 1 - {ⅇ}^{- α ( λ ) t} ) S ( λ ) {η}_{e} ( λ ) ⅆ λ}{wL} \qquad ( 2 )$$

where R_{c} is the reflectivity of one surface of the collector and ηₑ the energy-conversion efficiency of the dye. It is not necessary to know E_{A} explicitly for optimisation of concentration to minimise losses, but it is necessary for total output, since E_{A} also depends on concentration via α(λ).

Finally, the useful power output P (in Watts) for lighting is calculated by summing over all wavelengths taking account of the spectral sensitivity of the eye given by the photopic function y(λ). Its equivalence in lumens F, is given by:

$${F}_{cu} = σ {\int }_{{λ}_{min}}^{{λ}_{max}} ⅆ l {\int }_{0}^{L} ɛ ( λ , L ) y ( λ ) ⅆ λ \qquad ( 3 )$$

where σ is the lumens per watt at the peak response of the eye. For photoptic vision σ is 683 lumens per watt.

F is tabulated or plotted as a function of dye concentration and the optimum concentration is that for which it is maximised.

Dye cost could also be taken into account if desired in determining a final optimum though in general it will be a minor consideration since dye cost forms a very small part of total system cost.

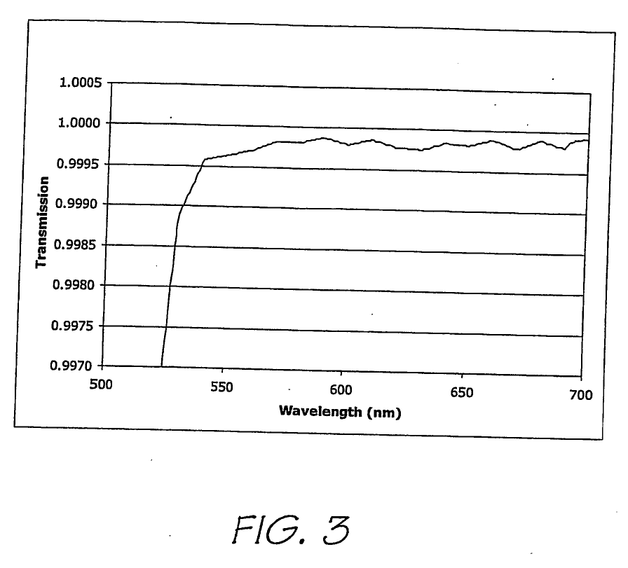

FIG. 3 shows a transmission versus wavelength plot (solid line) for a light collector doped with green dye molecules and fabricated according to the preferred method.

In the following effects of design variations will be considered.

The optimum dye concentration calculation approaches previously used had assumed self absorption, and indeed all dye linked attenuation, had lost their influence after the light had travelled a few cm with further absorption coefficient losses for longer distance measured in attenuation measurements on full sheets, then due to host matrix scattering. The above-described improved approach results in an optimum concentration that is lower than that calculated using the old approach. For example, the above-described improved approach results for a green output collector sheet (dimensions 135 mm×1200 mm×2 mm with output at one 135 mm wide edge, and a sub sheet and one edge reflector) in a concentration of green emitting dye that increases the sheet's output by approximately 20% compared to the old method.

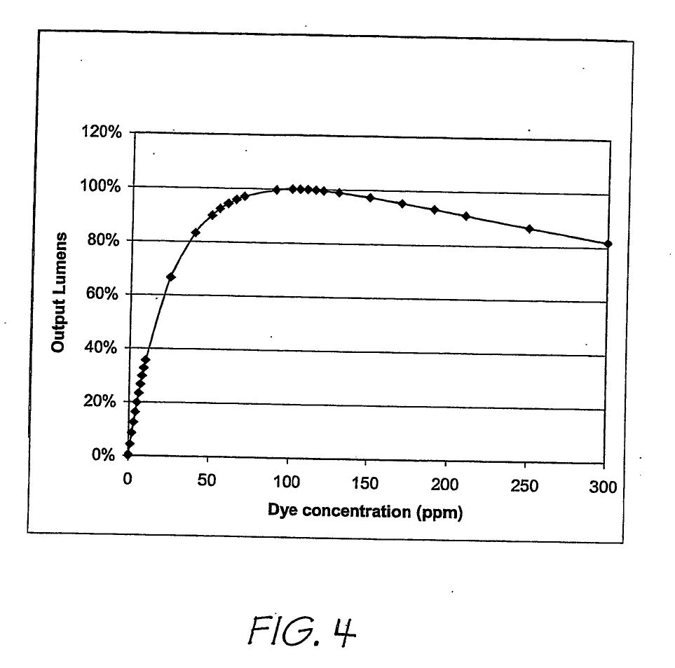

FIG. 4 shows the calculated output lumens for a collector sheet doped with green light emitting dye molecules. The output was calculated using the above-described improved method and for the calculation the sheet had the dimensions 135 mm×1200 mm×2 mm. As can be seen from the Figure, the output lumens are maximised for a dye concentration of approximately 105 ppm.

Variations in the optimum concentration and associated calculation can result from additional or improved design features. The most likely additional influence is that of a strong reflector, either white diffuse or specular metallic, placed beneath the sheet and then an edge reflector at the edge opposite the output edge, as were both used in the above calculation. The under sheet reflector means less dye can be used to obtain the same or higher E_{A} value since non-absorbed light on the first pass can be largely absorbed after reflection. Less dye also reduces transport losses so the effect of this reflector contributes to improved performance in two ways, and can significantly change the optimum concentration. A simplified approach to the effect of a sub-sheet reflector is to change t in the equation for E_{A} to 2t. Alternately a fully accurate calculation including the reflectance of the sub-sheet can be made, although in practice this leads to small changes (any wavelength dependence of mirror or sheet reflectance which should be small could also be included or neglected). The edge reflector requires an additional term to the integral in equation (1), in which 1 is relaced by (2L−l), assuming a perfect edge reflector. This terms is also improved for lower attenuation in the emission band, as it requires output light to travel further than in the first term.

The above consideration concerned single sheet calculations. Optimisation of concentration can also be further refined if desired for each different dyed sheet according to its position in a complete collector which will use typically three, or sometimes two dyed sheets, in a stack. For instance, violet, green and red in that order, with a reflector beneath the whole stack. In this case it is necessary to calculate the power spectra that is impinging on each sheet at each pass (i.e. on way down and way up after reflection), after it has been modified by passing through any sheets above or below. This includes any light not absorbed in prior passes through any sheets and fluorescence light emitted from sheets either side. In this case in equation (2) above for each sheet S(λ) is replaced by the incident power spectrum S_{v,g,} (λ), with subscript v, g and r, and so on, labels as appropriate for the sheets with different coloured dyes which solar energy has previously passed through, if any. These spectra are determined by multiplying the incident spectrum in the sheet above, by its spectral transmittance. For example after crossing the top violet sheet the spectrum incident on the green below it in a three-layer stack is
Sᵥ(λ)=Tᵥ(λ)S(λ) (4)
with Tᵥ(λ) the spectral transmittance of the violet sheet. Modifications of the incident spectra in this way can change the optimum concentrations but again it is a secondary effect so the first simple approach modified by a base reflector will often suffice, even for a multi-layer, multi-dye system. Fluorescence light output from above or below can be added and results in slight changes.

After the dye concentration has been calculated, the collector sheets are fabricated using any known methods. For example, the fabrication methods as disclosed in U.S. Pat. No. 6,059,438 may be used.

It is to be understood that the reference that is made to U.S. Pat. No. 6,059,438 and to the publication by Swift et al does not constitute an admission that the documents form a part of the common general knowledge in the art, in Australia or any other country.

Although the invention has been described with reference to particular examples, it will be appreciated by those skilled in the art that the invention may be embodied in many other forms.

1-23. (canceled)

24. A light collector having a dye molecule concentration C, the dye molecules being dispersed in a light transmissive medium, the concentration C being selected to reduce attenuation that light will suffer due to reabsorption or scattering in the main emission wavelength range of the dye molecules so that the combined emission and absorption efficiency of the light collector is increased.

25. The light collector as claimed in claim 24 having a thickness t and wherein the concentration C is selected so that the product of C and t is between 320 and 200 ppm*mm.

26. The light collector as claimed in claim 24 having a thickness t and wherein the concentration C is selected so that the product of C and t is between 200 and 160 ppm*mm.

27. The light collector as claimed in claim 24 having a thickness t and wherein the concentration C is selected so that the product of C and t is between 160 and 120 ppm*mm.

28. The light collector as claimed in claim 24 having a thickness t and wherein the concentration C is selected so that the product of C and t is between 120 and 80 ppm*mm.

29. The light collector as claimed in claim 24 having a thickness t and wherein the concentration C is selected so that the product of C and t is between 80 and 40 ppm*mm.

30. The light collector as claimed in claim 24 having a thickness t and wherein the concentration C is selected so that the product of C and t is between 40 and 20 ppm*mm.

31. The light collector as claimed in claim 24 having a thickness t and wherein the concentration C is selected so that the product of C and t is less than 20 ppm*mm.

32. The light collector as claimed in claim 24 having a dye concentration that is selected such that the combined emission and absorption efficiency of the light collector is optimized.

33. The light collector as claimed in claim 24 wherein the dye molecules are distributed such that at least a majority of the dye molecules are not directly bonded to one another.

34. The light collector as claimed in claim 24 wherein the dye molecules are substantially uniformly distributed throughout the light collector.

35. A light collector having a dye molecule concentration C and a corresponding output of fluorescence light Lₒᵤₜ, the dye molecules being dispersed in a light transmissive medium and the concentration C being lower than 500 ppm, the concentration C being smaller than a concentration C′ and the output of fluorescence light Lₒᵤₜ being larger than the output the light collector would have if the concentration is C′.

36. The light collector as claimed in claim 35 having a thickness t and wherein the concentration C is selected so that the product of C and t is between 320 and 200 ppm*mm.

37. The light collector as claimed in claim 35 having a thickness t and wherein the concentration C is selected so that the product of C and t is between 200 and 160 ppm*mm.

38. The light collector as claimed in claim 35 having a thickness t and wherein the concentration C is selected so that the product of C and t is between 160 and 120 ppm*mm.

39. The light collector as claimed in claim 35 having a thickness t and wherein the concentration C is selected so that the product of C and t is between 120 and 80 ppm*mm.

40. The light collector as claimed in claim 35 having a thickness t and wherein the concentration C is selected so that the product of C and t is between 80 and 40 ppm*mm.

41. The light collector as claimed in claim 35 having a thickness t and wherein the concentration C is selected so that the product of C and t is between 40 and 20 ppm*mm.

42. The light collector as claimed in claim 35 having a thickness t and wherein the concentration C is selected so that the product of C and t is less than 20 ppm*mm.

43. The light collector as claimed in claim 35 having a dye concentration that is selected such that the combined emission and absorption efficiency of the light collector is optimized.

44. The light collector as claimed in claim 35 wherein the dye molecules are distributed such that at least a majority of the dye molecules are not directly bonded to one another.

45. The light collector as claimed in claim 35 wherein the dye molecules are substantially uniformly distributed throughout the light collector.

46. A method of fabricating a light collector being doped with dye molecules that, in use, absorb light having a wavelength within an absorption wavelength range and emit light having a wavelength within an emission wavelength range, the method comprising
calculating a concentration of the dye molecules taking into account the attenuation that emitted light will suffer owing to re-absorption or scattering in the main emission wavelength range and thereby taking into account that the fluorescence light output Lₒᵤₜ is reduced for dye concentrations above an optimum value.

47. The method as claimed in claim 46 comprising the additional step of selecting the dimensions of the light collector and calculating the dye concentration for the selected dimensions.

48. The method as claimed in claim 46 wherein the step of calculating the dye concentration takes into account reflection properties of a medium that will be positioned adjacent to the light collector.

49. The method as claimed in claim 46 wherein the wavelength range in which attenuation is taken into account that extends beyond the main emission wavelength range.

50. The method as claimed in claim 46 wherein the wavelength range for which attenuation that is taken into account that extends to a wavelength of at least 50 nm longer than the wavelength that corresponds to maximum emission intensity.

51. The method as claimed in claim 46 wherein the wavelength range in which attenuation is taken into account extends from 380 to 480 nm.

52. The method as claimed in claim 46 wherein the wavelength range in which attenuation is taken into account extends from 400 to 580 nm.

53. The method as claimed in claim 46 wherein the wavelength range in which attenuation is taken into account extends from 460 to 700 nm.

54. The method as claimed in claim 46 wherein the wavelength range in which attenuation is taken into account extends from 530 to 700 nm.

55. The method as claimed in claim 46 wherein the step of calculating the dye concentration is conducted such that a dye concentration for optimum combined absorption and emission efficiency is obtained.

56. A light collector fabricated by the method as claimed in claim 46.
